(19) United States
(12) Patent Application Publication
(10) Pub. No.: US 2022/0041232 A1
(43) Pub. Date: Feb. 10, 2022

(54) U-Lock Mount for a Bike

(71) Applicant: David M. Greenberg, Oakland, CA (US)

(72) Inventor: David M. Greenberg, Oakland, CA (US)

(21) Appl. No.: 17/396,644

(22) Filed: Aug. 6, 2021

Related U.S. Application Data
(60) Provisional application No. 63/062,263, filed on Aug. 6, 2020.

(51) Int. Cl. B62H 5/00; B62J 7/04

(52) U.S. Cl. CPC B62H 5/00; B62H 2005/008; B62J 7/04

(57) ABSTRACT

A system for carrying a lock on a bicycle having a frame, the lock including a shackle having two substantially parallel portions and a crossbar having at least one locking component, the system including two tubing members having a diameter and spaced apart to receive each of the substantially parallel portions of the shackle into a corresponding one of the two tubing members and to allow the crossbar to be secured to the shackle on the other side of the tubing members; one or more mounting structures to couple the tubing members to the frame of the bicycle; wherein the lock when received by the tubing members and locked into place by the crossbar is positioned in a substantially perpendicular to the plane of the wheels of the bicycle.

### BACKGROUND

Bicycles (or bikes) are fast and efficient vehicles used by millions of people each year for transportation, leisure activities and health benefits. Many people invest a substantial amount of money into their bicycles for various reasons including to reduce frame weight, increase frame stiffness, and improve the quality of other components for smooth operation of the bicycle. Bicycles may be powered at least in part by an engine. In such case, the vehicle may be referred to as an electric bicycle or an electric bike.

The owner often wants to secure their bike in a public place while they eat a meal, visit a store, or run an errand. One of the most popular devices for securing a bike to a fixed location in a public place is a U-Lock. A U-Lock includes a U-shaped piece of hardened metal lockable to a crossbar. A U-Lock is meant to secure the bike by enclosing the frame of the bike to a securing object in the public place, such as a bike rack or a fence post. A U-lock is often referred to as a D-Lock because it may be shaped like the letter D when the crossbar is locked in place.

When a bike is left unattended after it is locked to a secure object in a public place, thieves may attempt to steal the bike. Thieves often attempt to steal a bike by finding the easiest method to separate the bike from the secure object.

If the owner had secured the bike to a less secure object that can be cut or uprooted, thieves may cut uproot the securing object to free the bike. If the bike can be manipulated to allow the U-Lock to be slid off the top of the securing object (e.g., short post), thieves may manipulate the bike to remove it from the securing object.

A U-Lock should be large enough to enclose a portion of the bike and some secure objects expected to be available in the course of travels on the bike. U-Locks are made with a wide range of shackles from wide and/or long so that owners can select which one accommodates the secure objects they expect to encounter during their use of their bike. But an owner may not want to select a shackle that is too large such that a thief could insert a lever into the enclosed space to use leverage to defeat the lock.

If the bike's owner properly secures the bike to a secure object, the security of the U-Lock generally comes down to the locking mechanism(s) and the diameter and hardness of the metal. U-Locks typically weigh about 3 to 5 pounds. Their large form factor distributes this weight over an area can make the U-Lock awkward to carry on a bike.

A U-Lock is typically secured through the frame (a strong, expensive and core part) of the bike. If the U-Lock is positioned such that it secures a weak or inexpensive portion of the bike, thieves may sacrifice that portion to steal the rest of the bike.

The owner typically carries a U-Lock with them as they travel on the bicycle. Often U-Lock manufacturers include cheap plastic mounts to carry the U-Lock on the frame or rack while riding. Because of the nature of the materials and construction, the U-Locks often rattle when mounted by such devices and can come loose and fall off while riding the bike.

What is needed is a method for securely mounting a U-lock to a bike.

What is needed is a method for preventing a U-Lock from vibrating or otherwise coming loose when mounted on a bike.

What is needed is a method for preventing a U-Lock from rattling or otherwise making noise when mounted on a bike.

### FIGURES

FIG. 1 is one embodiment of a U-Lock that is opened.

FIG. 2 is one embodiment of a U-Lock that is locked using a side locking mechanism.

FIG. 3 is another embodiment of a U-Lock that is locked using a middle locking mechanism.

FIG. 4 is a first embodiment of a U-Lock mount of the present invention.

FIG. 5 is the first embodiment of a U-Lock mount of the present invention mounted to the frame at the rear wheel of a bicycle.

FIG. 6 is a second embodiment of a U-Lock mount of the present invention.

FIG. 7 is the second embodiment of a U-Lock mount of the present invention mounted to the frame at the front wheel of a bicycle.

FIG. 8 an embodiment of a U-Lock mount of the present invention with an adjustable U-Lock that is unextended.

FIG. 9 an embodiment of a U-Lock mount of the present invention with an adjustable U-Lock that is extended.

FIG. 10 is an embodiment of an extendable support.

FIG. 11 is an embodiment of an extendable support.

FIG. 12 an embodiment of a U-Lock mount of the present invention with an adjustable width.

FIG. 13 is an embodiment of an extendable spacer.

### DETAILED DESCRIPTION

A U-Lock is a device often used to secure a bicycle when making a stop in a public place using a bicycle. U-Locks (sometimes referred to as D-Locks) are typically used to enclose a bike frame and a secure object, such as a bike rack, fence or sign post.

These locks are often made of hardened steel for at least the reason that such material can make it more difficult to cut with bolt cutters and other devices thieves may use. Generally, the weight of a U-Lock ranges is between 3.0 and 5.0 pounds.

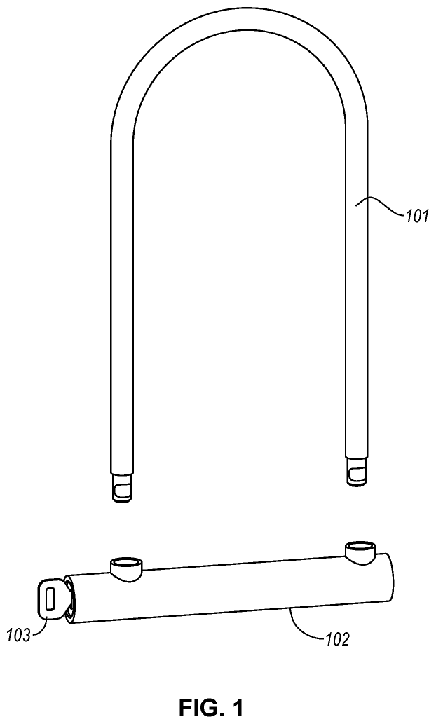

FIG. 1 shows one embodiment of a U-Lock. The lock is typically formed of an elongated rounded shackle 101 with a large diameter that can make it more difficult to cut with bolt cutters and other devices thieves may use. Typically, shackle diameters of U-Locks for bikes are about 13 to 18 millimeters. In some embodiments, the U-Lock shackle and crossbar may be covered with a rubberized layer which prevents damage to the bicycle.

The shackle 101 forms two parallel rounded portions that meets with a crossbar 102, also substantially rounded, that lockably couples the two parallel rounded portions to enclose a space in between. The crossbar 102 is locked to the shackle 101 using a key 103 in a locking mechanism internal to the crossbar 102 (not shown).

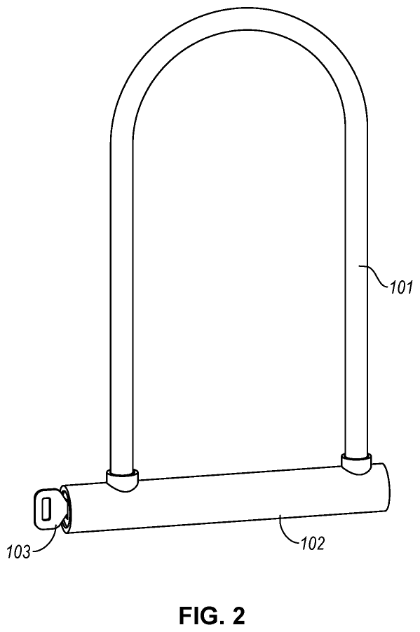

FIG. 2 illustrates the U-Lock having the shackle 101 locked to the crossbar 102 using the key 103 inserted into a locking mechanism on a lateral side of the crossbar 102.

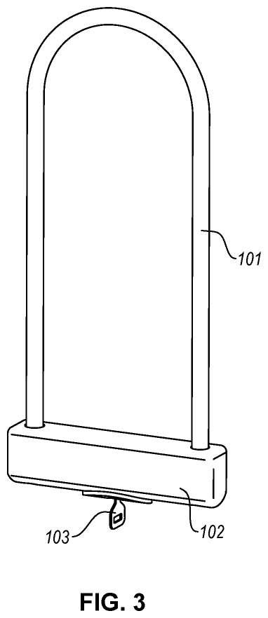

FIG. 3 illustrates the U-Lock having the shackle 101 locked to the crossbar 102 using the key 103 inserted into a locking mechanism in the middle of the crossbar 102.

Typically, the spaced apart parallel rounded portions of a shackle 101 are about 3.0 to 6.0 inches apart from the closest portions (interior dimension) of each parallel rounded portion. Typically, the shackle is about 3.0 to 12.0 inches from the crossbeam to the farthest end of the shackle (interior portion) when locked in place. These weights, thicknesses, widths, lengths may be used for securing a bike to a secure member. This invention may be applied to locks with other weights, thicknesses, widths, and lengths.

One effect of having such a heavy weight spread over a relatively large, enclosed area is that the U-lock can be relatively awkward to carry on the bike.

Prior art methods of mounting commercial U-Locks to bicycles often involve plastic straps that secure an end of the U-Lock to the frame. These mounts have many deficiencies including a tendency to hold the U-Lock in a position which cause the U-Lock to wobble and rattle. As a result, the U-Lock may fall off and be lost.

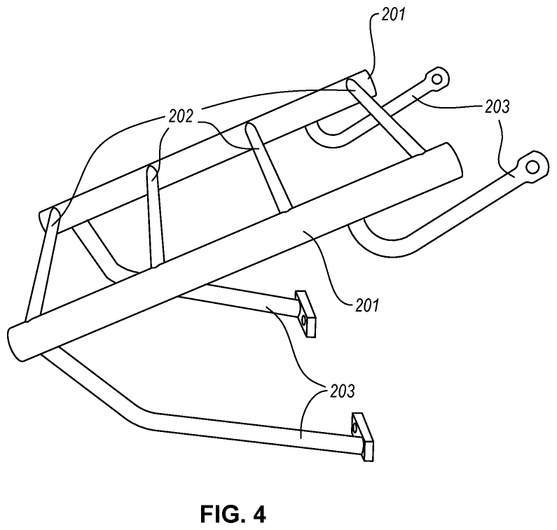

FIG. 4 illustrates one embodiment of a rack for a U-Lock of the present invention. The rack includes a pair of tubular members 201 spaced apart by spacers 202 so that the tubular members 202 can receive the parallel members of a shackle 101 in one end and be locked in place on the other end by the crossbar 102.

The spacers are intended to space the tubular members apart by a spacing associated with the parallel members of the U-Lock shackle. That is, if the parallel members of the shackle 101 are spaced apart 4 inches center-to-center, the tubular members 201 may be spaced apart 4 inches center-to-center.

The tubular members 201 also have a diameter. If the diameter of the shackle 101 is 18 millimeters, the diameter of the tubular members 201 should have a diameter of 18 mm plus a few millimeters to allow some room for the shackle 101 to slide through the tubular members.

In another embodiment, the tubing members may be removably coupled to the structure so that tubing members that accommodate different ranges of shackle diameters may be used. In yet another embodiment, tubing inserts may be installed into a tubing member to reduce the gap for smaller shackles.

The rack also has support structures 203 to couple the tubular members to a bicycle.

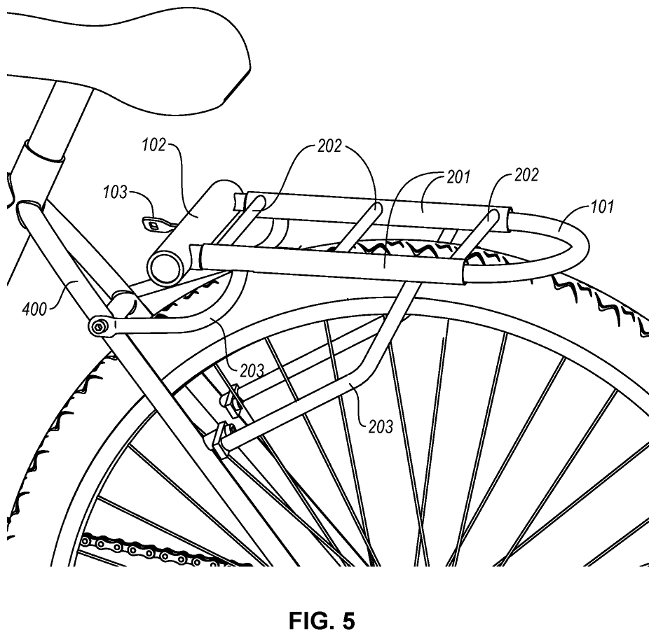

FIG. 5 illustrates the rack of FIG. 4 mounted by the support structures 203 to the frame 400 of a bicycle at the rear wheel. In a preferred embodiment, the support structures are positioned and shaped so that the U-Lock is positioned in a plane perpendicular to the plane the wheel rotates through and centered laterally along the lateral center of the bike.

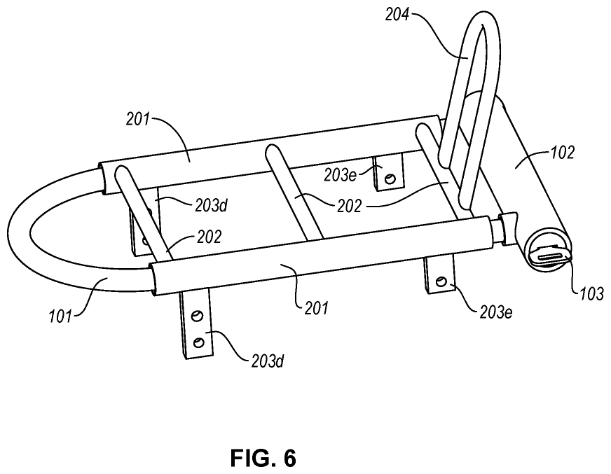

FIG. 6 illustrates one embodiment of a rack for a U-Lock of the present invention with an inserted U-Lock. The rack includes a pair of tubular members 201 spaced apart by spacers 202 so that the tubular members 201 can receive the parallel members of a shackle 101 in one end and be locked in place on the other end by the crossbar 102.

The spacers 202 space the tubular members apart by a spacing associated with the parallel members of the U-Lock shackle. That is, the tubular members 201 would be spaced apart 4 inches center-to-center in order to receive a U-Lock having parallel members of the shackle 101 which were spaced apart 4 inches center-to-center.

The tubular members 201 each have a diameter. If the diameter of the shackle 102 is 18 millimeters, the diameter of the tubular members 201 should have a diameter of 18 mm plus at least a few millimeters to allow some room for the shackle 101 to slide through the tubular members.

The rack also includes a tombstone 204 that holds any load mounted on top of the rack away from the crossbar 102 (or the area that would contain the crossbar 102) so the U-Lock can be loaded or unloaded when the load is in place. The load may include a basket, for example, that is coupled to the rack with bungee cords.

In some embodiments, the rack for the U-Lock does not have a tombstone 204. In some embodiments, the rack may be integrated into any number of additional structures meant to hold a load on the front or rear of the bicycle. In some embodiments, sufficient spacing is built-in between the tubular members 201 and the additional structures to allow for easy loading and unloading of a U-Lock, even with a load on the additional structures.

The rack also includes straps-with-two-holes 203d and straps-with-one-hole 203e. These are used to mount the rack to a bicycle. In some embodiments, different brands or models of bicycles may require different support structures of different lengths to attach to these straps.

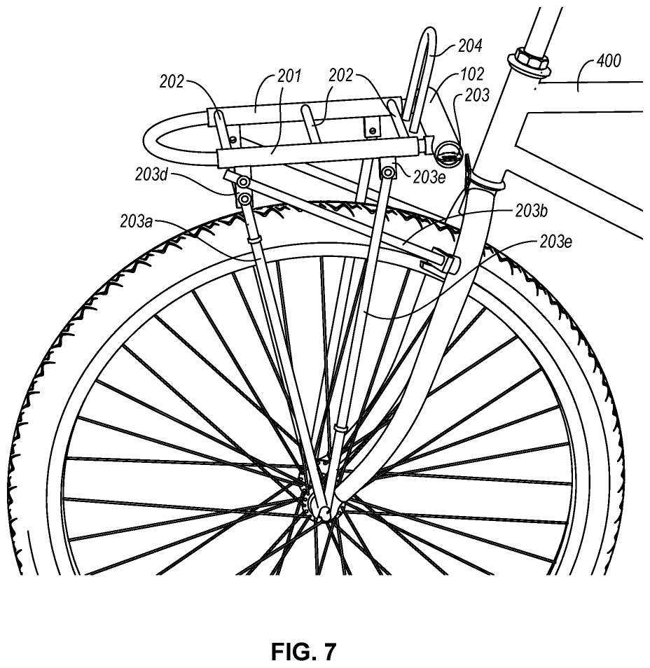

FIG. 7 illustrates the rack of FIG. 6 mounted by the support structures 203a, 203b, and 203c to the frame 400 of a bicycle at the front wheel. In a preferred embodiment, the support structures are positioned and shaped so that the U-Lock is positioned in a plane perpendicular to the plane the wheel rotates through and centered laterally along the lateral center of the bike.

The top hole of the two straps 203d are supported at the frame 400 by adjustable length support structures 203b. The bottom holes of the two straps 203d and the hole of the strap 203e are supported at the ends of the fork of the frame 400 by adjustable length support structures 203a and 203c.

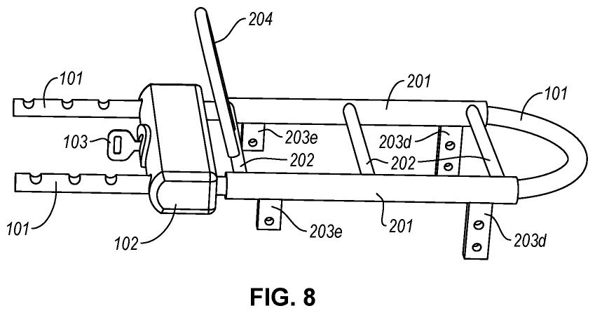

FIG. 8 illustrates one embodiment of a rack for an adjustable-length U-Lock of the present invention with an inserted U-Lock. The rack includes a pair of tubular members 201 spaced apart by spacers 202 so that the tubular members 202 can receive the parallel members of a shackle 101 in one end and be locked in place on the other end by the crossbar 102.

Some users want a long shackle to have some flexibility in terms of which secure objects the bike may be attached in their travels. But when they do not need a lot of enclosed area they may wish to tighten up the area using notches in the shackle 101 as shown in FIG. 8.

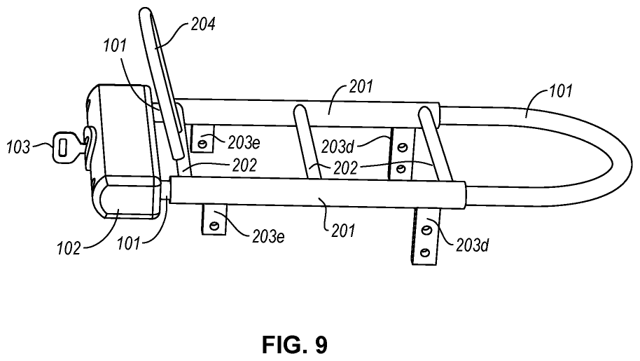

When they do need a lot of area they may wish to extend the area using adjustments as shown in FIG. 9. This may also allow them to have the shackle extend further out the rear of the bike. Users may even hang a rear bike light on the extended portion of the shackle when mounted on the bike.

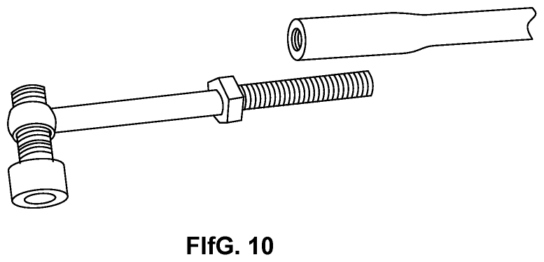

FIG. 10 shows one end of a support structure of the present invention. One end is screwed into the other to adjust the length.

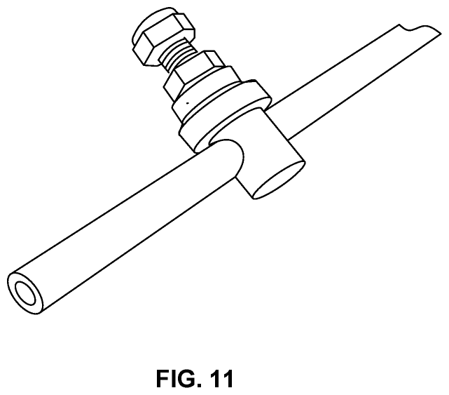

FIG. 11 shows one end of a support structure of the present invention. One end is slides along the support structure to a desired length and then the second screw is clamped down to hold it in place.

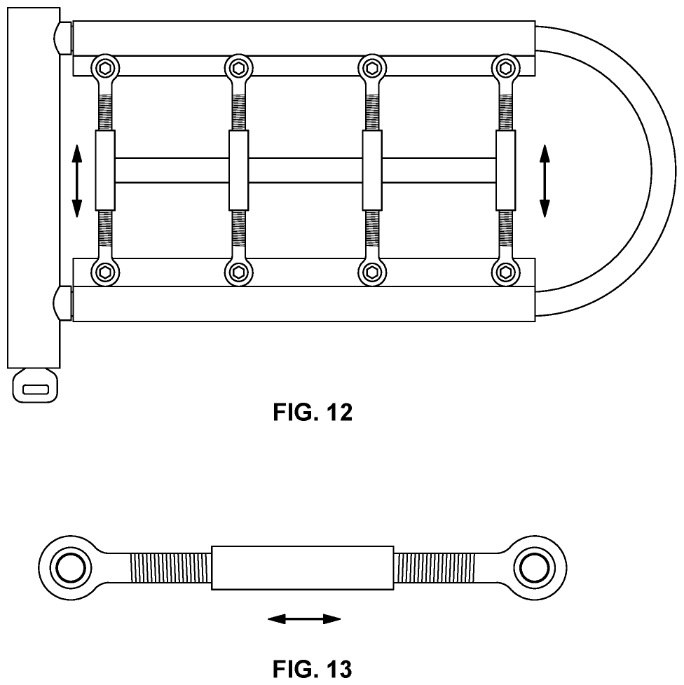

FIG. 12 illustrates one embodiment of a rack for a U-Lock of the present invention. The rack includes a pair of tubular members 201 spaced apart by adjustable spacers so that the tubular members 202 can receive the parallel members of a shackle 101 in one end and be locked in place on the other end by the crossbar 102.

FIG. 13 illustrates one embodiment of an adjustable spacer of the present invention. Each of two screwholes are adjustably positioned on opposite sides by thread into a nut.

One advantage of a system for securely holding the U-Lock in an centered balanced position is that large U-Locks can be accommodated. The present invention is not limited to any particular width, length or weight of U-Lock.

1. A system for carrying a lock on a bicycle having a frame, the lock comprising a shackle having two substantially parallel portions and a crossbar having at least one locking component, the system comprising:
two tubing members having a diameter and spaced apart to receive each of the substantially parallel portions of the shackle into a corresponding one of the two tubing members and to allow the crossbar to be secured to the shackle on the other side of the tubing members;
one or more mounting structures to couple the tubing members to the frame of the bicycle;
wherein the lock when received by the tubing members and locked into place by the crossbar is positioned in a substantially perpendicular to the plane of the wheels of the bicycle.

2. The system of claim 1 wherein the two tubing members are coupled to the bottom of a bike rack or bike basket configured to carry a load, wherein insertion or removal of the lock does not require removal of the load.

3. The system of claim 1 wherein each of the one or more mounting structures includes one or more adjustments to position the system according to the mounting points of the frame.

4. The system of claim 1 wherein the tubing members are spaced apart adjustable according to the distance between each of the substantially parallel portions of the shackle.

5. The system of claim 1 wherein the tubing members have an adjustable diameter according to the diameter of the substantially parallel portions of the shackle.

6. The system of claim 1 wherein the lock is one of a u-lock or d-lock.

7. The system of claim 1 wherein the lock comprises a shackle of hardened steel.

8. The system of claim 1 wherein the lock wherein the at least one locking component is at least one of a key lock or a combination lock.

9. The system of claim 1 wherein the lock weighs between 3 and 5 pounds.

10. The system of claim 1 wherein the tubing members are spaced apart by a plurality of bars coupled on each end to a corresponding one of the tubing members.

11. The system of claim 1 wherein the mechanisms to couple the tubing members to the bicycle are mounted to the

[symbol]

12. The system of claim 1 wherein the diameter of the tubing members is between approximately 13 and 18 millimeters.

13. The system of claim 1 wherein the diameter of the tubing members has a diameter that is approximately 1-5 millimeters greater the diameter of parallel portions of the shackle.

14. The system of claim 1 wherein the length of the tubing members is between 3.0 and 14.0 inches.

15. The system of claim 1 wherein the tubing members are spaced apart between 3.0 and 6.0 inches.

16. The system of claim 1 wherein the two tubing members spaced apart form a structural basis of at least one of a rear rack or front basket of the bicycle.

17. The system of claim 1 wherein a tail-light is mounted to the curved end of the shackle to hang on the rear of the bicycle.
